(19) United States
(12) Patent Application Publication
(10) Pub. No.: US 2015/0129181 A1
(43) Pub. Date: May 14, 2015

(54) MODULAR HEAT EXCHANGER

(71) Applicant: Tranter, Inc., Wichita Falls, TX (US)

(72) Inventors: Rhorn J. John, Wichita Falls, TX (US); Creed Taylor, Signal Mountain, TN (US)

(21) Appl. No.: 14/536,716

(22) Filed: Nov. 10, 2014

Related U.S. Application Data
(60) Provisional application No. 61/902,548, filed on Nov. 11, 2013.

(51) Int. Cl. F28D 9/00; B23P 15/26

(52) U.S. Cl. CPC F28D 9/0006; B23P 15/26
USPC 165/157; 29/890.039

(57) ABSTRACT

In at least some implementations, a shell and plate heat exchanger includes a shell and a core. The shell defines at least part of an interior and has a lid and a main body to which the lid is coupled in assembly. The core may be received in the interior and have a plurality of modules. Each module may include a plurality of cassettes of heat transfer plates, and the modules may be releasably coupled together to enable nondestructive decoupling of at least one module from the core. To permit nondestructive removal of the lid from the main body, the lid and main body may be releasable coupled together.

### REFERENCE TO CO-PENDING APPLICATION

This application claims the benefit of U.S. Provisional Application No. 61/902,548 filed Nov. 11, 2013, which is incorporated herein by reference in its entirety.

### TECHNICAL FIELD

This disclosure relates to the shell and plate heat exchanger having a core that is removable from a shell.

### BACKGROUND

The feedwater for steam generators in nuclear power plants is typically preheated before being introduced into the secondary side of the steam generators. Similarly, feedwater is preheated before being introduced into boilers for non-nuclear power plant applications. Conventional shell and tube heat exchangers have been used for decades in nuclear and non-nuclear power plants to preheat feedwater. Such shell and tube exchangers experience degradation over time from tube vibration, flow accelerated corrosion, and loss of efficiency due to plugging of leaking tubes and high fouling rates. Repair or replacement of such equipment is time consuming and expensive.

### SUMMARY

In at least some implementations, a shell and plate heat exchanger includes a shell and a core. The shell defines at least part of an interior and has a lid and a main body to which the lid is coupled in assembly. The core may be received in the interior and have a plurality of modules. Each module may include a plurality of cassettes of heat transfer plates, and the modules may be releasably coupled together to enable nondestructive decoupling of at least one module from the core. To permit nondestructive removal of the lid from the main body, the lid and main body may be releasable coupled together.

A method of making a heat exchanger may include the steps of:

grouping a plurality of cassettes of heat exchanger plates into a module;

releasably coupling together a plurality of modules into a core; and

releasably mounting the core within the shell to permit nondestructive removal of the core from the shell and nondestructive removal of at least one module from the core. In at least some implementations, the shell includes a body and a lid releasably coupled to the body to define an interior and the core may be mounted to the lid prior to coupling the lid to the body. In this way, the core may be accurately aligned with the body and retained in place within the shell when the lid is coupled to the body.

In at least some forms, the core of the heat exchanger may be removed from the shell, preferably without damaging the shell or the core. The core generally, and/or modules of the core may be cleaned, separated, repaired, rebuilt and/or replaced, and a core may be replaced within the shell for continued use after such operations on any or all of the core modules. The modular construction of the core also facilitates building differently sized heat exchangers, where more modules may be included in a larger core and fewer modules in a smaller core. Of course, the modules need not be of the same size and construction and can vary as desired. For example, the modules may include different numbers of cassettes or plates, if desired, and the modules may have different diameters or shapes, to fit a particular application.

### BRIEF DESCRIPTION OF THE DRAWINGS

The following detailed description of preferred embodiments and best mode will be set forth with reference to the accompanying drawings, in which:

FIG. 1 is a perspective view of one embodiment of a heat exchanger showing a core removed from a shell of the heat exchanger;

FIG. 2 is a perspective end view of the heat exchanger;

FIG. 3 is a perspective side view of the heat exchanger;

FIG. 4 is cross-sectional view of a removable core and carriage assembly of the heat exchanger;

FIG. 5 is an end view of a main body of a shell of the heat exchanger and a base that carries the main body;

FIG. 6 is a cross-sectional view taken generally along line 6-6 of FIG. 5;

FIGS. 7 and 8 are perspective views of the core coupled to a lid of the shell;

FIG. 9 is a front view of a plate pack module of the core;

FIG. 10 is a side view of the plate pack module;

FIG. 11 is a perspective view of the plate pack module;

FIG. 12 is a sectional view taken generally along line 12-12 in FIG. 9;

FIG. 13 is a front view of a baffle plate;

FIG. 14 is a perspective view of an alternate heat exchanger including two cores; and

FIG. 15 is a cross-sectional view of the heat exchanger of FIG. 14.

### DETAILED DESCRIPTION OF PREFERRED EMBODIMENTS

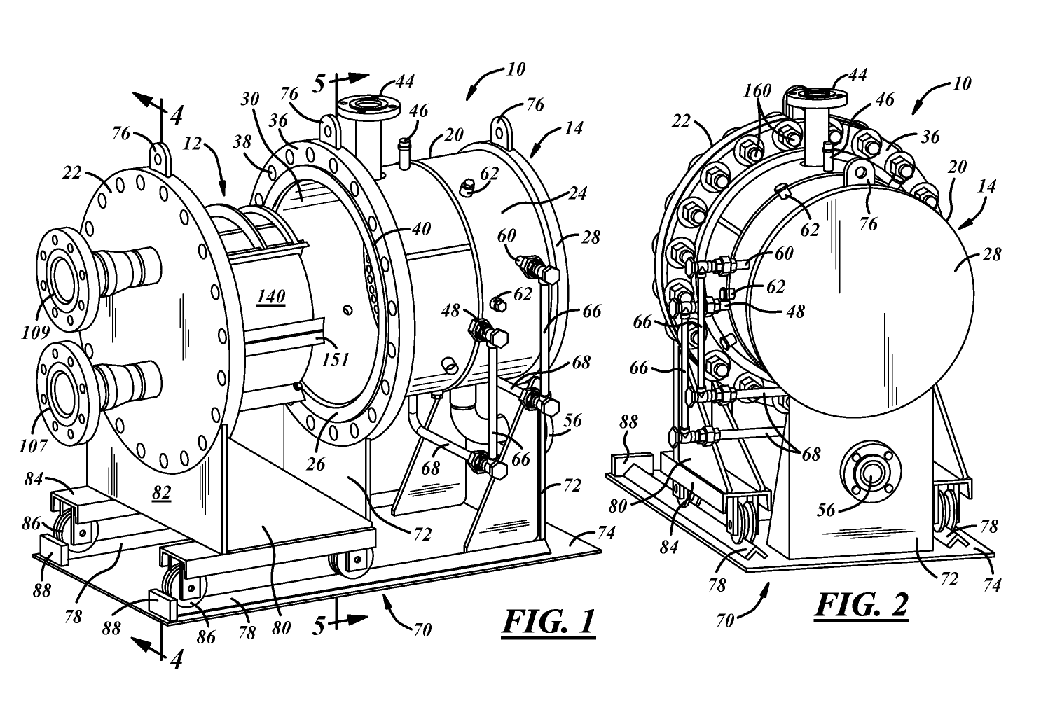

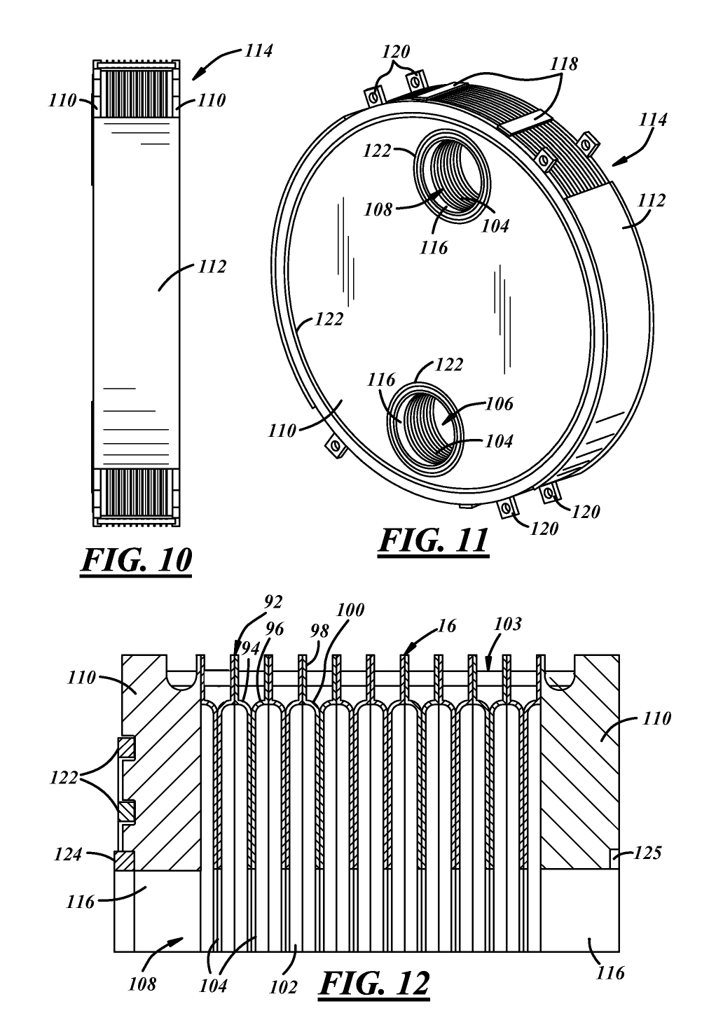

Referring in more detail to the drawings, FIGS. 1-3 illustrate a heat exchanger 10 that has a core 12 releasably or removably carried by a shell 14. In the implementation shown, the heat exchanger 10 is a shell and plate construction with the shell 14 defining an outer housing and the core 12 including a plurality of plates 16 (FIGS. 4 and 7-12) located within the shell to define at least portions of fluid flow paths for treatment and working fluids to effect heat transfer between the fluids. In use, a treatment fluid is fed to the heat exchanger 10 at a different temperature than a working fluid, and heat transfer between the fluids and the heat exchanger components either raises or lowers the temperature of the working fluid to a desired level. In one presently contemplated implementation, the working fluid is feedwater for a boiler, steam generator or reactor in a power generation plant and the treatment fluid is a fluid at an elevated temperature, like steam, that is used to heat the feedwater. Of course, other implementations are possible.

The shell 14 may include a main body 20 and a lid 22 that is connectable to the main body to define an interior or enclosure in which the heat exchanger plates 16 are received. As shown, the lid 22 may be a flat plate adapted to be sealed to the main body, as will be discussed below. The main body 20 and lid 22 may be of any suitable shape and construction to contain the heat exchanger plates 16 and permit desired fluid flows and are not limited to the shape and construction shown in the drawings and further described herein.

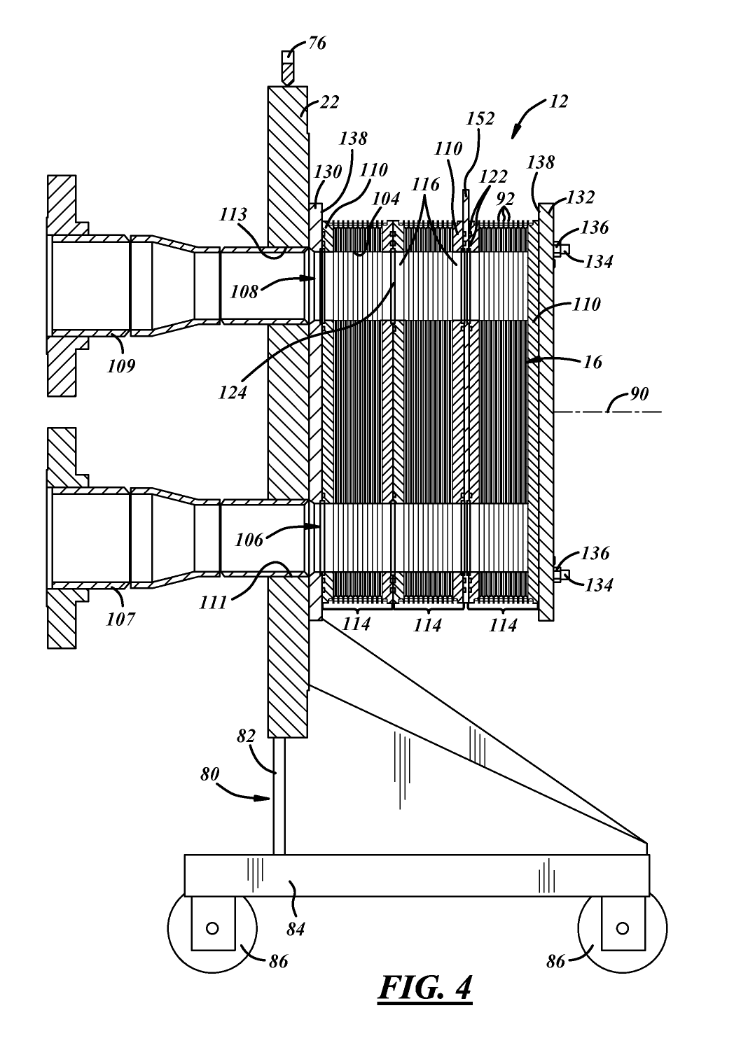

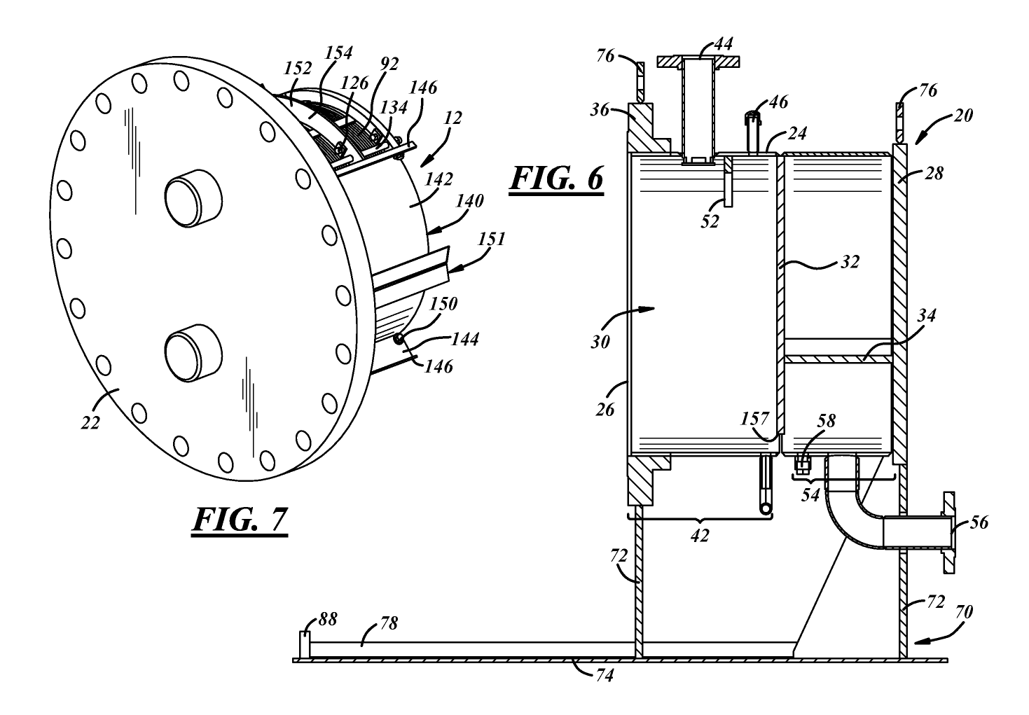

In the implementation shown, the main body 20 has a hollow cylindrical sidewall 24, is open at one end 26 and closed at its other end by an end plate 28 to define an open-ended interior 30. The main body 20 may be formed from one or several interconnected pieces of material. As shown in FIGS. 5 and 6, a divider 32 may extend into the shell interior 30 at a location spaced from the end plate 28 to define separate zones within the main body 20. While being shown as parallel to the end plate 28, the divider 32 need not be so arranged. Spacers or supports 34 may be disposed between the divider 32 and end plate 28. To facilitate connection of the lid 22 to the main body 20, a mounting flange 36 may be provided adjacent to the open end 26 of the sidewall 24. The flange 36 may extend radially outwardly from the sidewall 24 and include a plurality of openings 38 for receipt of connection members (bolts in the illustrated embodiment) that removably or releasably connect the lid 22 to the main body 20. An outer surface 40 of the flange 36 may be generally planar and fitted with a gasket or other seal to permit a fluid tight connection between the lid 22 and flange 36.

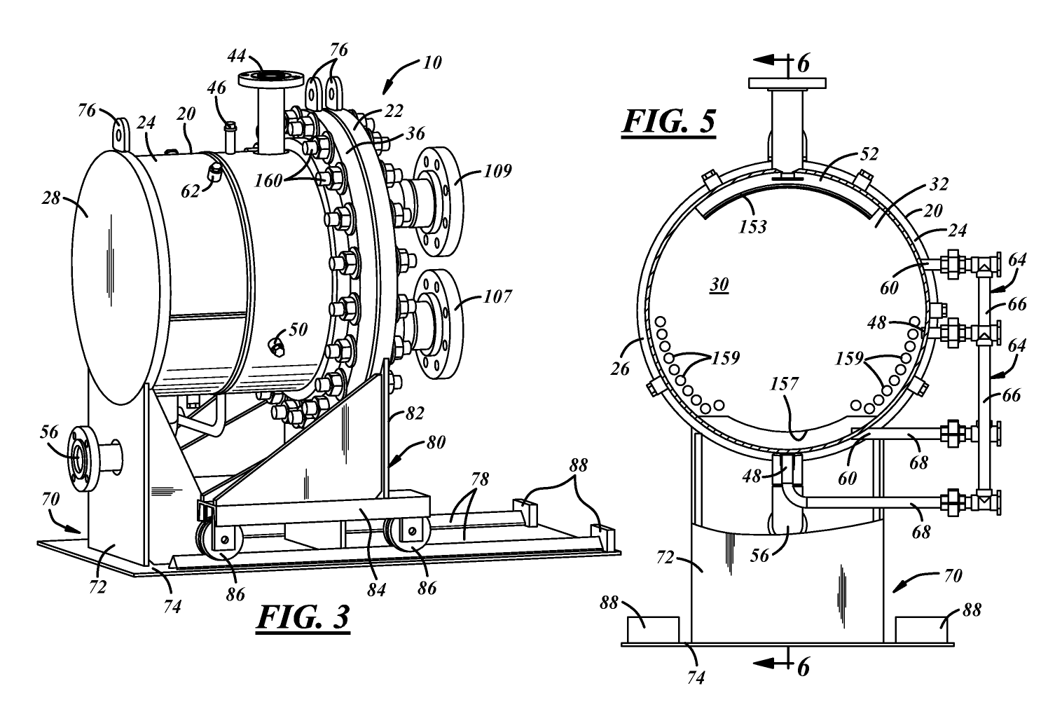

A first zone 42 (FIG. 6) of the shell interior 30 is adjacent to the open end 26 of the main body 20 and communicated with a first fluid inlet 44 for a treatment fluid, a second fluid inlet 46 (for a second treatment fluid in embodiments where such is provided), one or more fluid taps 48 (e.g. for a fluid level gauge) and one or more vents 50 (FIG. 3). This first zone 42 is adapted to receive the core 12 and its heat exchanger plates 16 that define a flow path or circuit for the treatment fluids received through the inlet 44 and/or inlet 46. At least in embodiments where two treatment fluids flow into the heat exchanger, a structure carried by the shell, shown as a baffle flange 52, may extend generally radially inwardly from the shell sidewall 24 part way into the first zone 42 between the first fluid inlet 44 and second fluid inlet 46. The baffle flange 52 may be sealed to the shell sidewall 24, if desired. This helps to maintain the two treatment fluids separate from each other as will be discussed below.

A second zone 54 (FIG. 6) of the shell interior 30 is adjacent to and may be defined in part by the end plate 28 and divider 32. The second zone 54 is communicated with an outlet 56 for the treatment fluid, a drain 58, one or more taps 60 (e.g. for a fluid level gauge) and one or more vents 62. The second zone 54 may act as an overflow volume to receive drainage or condensate should a component in the heat exchanger fail (e.g. leakage from the core). This may limit or prevent such fluid from being passed to an upstream component like a power plant turbine.

Either or both of the first and second zones 42, 54 may include level gauges 64 to facilitate determination of fluid levels in these zones. The level gauges 64 may be of any construction and arrangement suitable to provide or enable an indication of fluid level. In the example shown, both the first and second zones 42, 54 include level gauges 64 and both gauges include fluid taps 48, 60 through the sidewall 24, a sight tube 66 (transparent tube in which fluid level can be viewed) and conduit 68 leading from the taps to the sight tubes 66.

The shell 14 may be carried by a base 70 that may include one or more legs 72 coupled to the shell, for example, at or near the flange 36 and end plate 28, as shown. The legs 72 may extend to a floor or base plate 74, and with a base plate, the entire assembly may be unitized and capable of being moved as a unit. For this purpose, lugs 76 or other attachment features may be provided for moving the unit. To facilitate and/or control movement of the core 12 relative to the base 70, as will be described in more detail later, a guide, which may include guide rails 78, tracks or other features, may be associated with the base 70, such as by being connected to or carried by the floor or base plate 74.

The lid 22 and core 12 may be operably coupled to rails 78 for guided movement of the core 12 relative to the main body 20 of the shell 14 to permit insertion and withdrawal of the core 12 from the main body 20. In the implementation shown, the core 12 is connected to a carriage 80 that has an upright support 82 coupled to the lid 22 and a base 84 with a plurality of wheels 86 that roll along the rails 78. The rails 78 may be an inverted v-shape and the wheels 86 may have complementary grooves therein to retain and more precisely guide the carriage movement. Movement of the carriage 80 and an assembly of the lid 22 and core 12 may be achieved manually, or with a powered assist such as an electric, pneumatic or hydraulic mover (e.g. a motor or cylinder). The carriage and guide (e.g. rails 78) may be located outside of the shell, if desired. This may facilitate alteration, cleaning or repair of the carriage and guide without having to disassembly the heat exchanger. Of course, other arrangements of guided movement, linear or otherwise, may be utilized and the above are merely examples of certain possible types. If desired, one or more stops 88 may be provided along or at an end of the rails 78 to limit movement of the core 12 away from the main body 20.

As noted above, the core 12 is coupled to the carriage 80 for movement relative to the shell interior 30 between assembled and disassembled positions. The core 12 can be any suitable heat exchanger core but, as shown, preferably includes a plurality of stacked plates 16. Referring to FIGS. 4 and 6-11, the core 12 may have a plurality of corrugated plates 16 stacked along a longitudinal axis 90. The plates 16 may have any suitable shape and are shown as having a round periphery of a size for receipt within the shell interior 30. In particular, in one implementation the plates 16 are arranged in a group of cassettes 92 defining a cylinder of connected plates, as best shown in FIGS. 9-12. As best shown in FIG. 12, each cassette 92 may have a first plate 94 and a second plate 96 welded to the first plate 94 along the plate ports. Further, each first and second plate 94, 96 may be corrugated, somewhat flexible and resilient. If desired, each plate 16 of a cassette 92 may be the same shape and when one plate of a cassette 92 is inverted relative to the other plate, the outer edge portions 98 lie flat against each other and other portions 100 diverge away from each other defining a passage 102 between the plates of a cassette. Adjacent cassettes 92 may be welded or otherwise sealed together at their peripheries. Separate fluid passages 103 are also provided and may be open to the periphery of the plate pack as will be discussed later.

In the example shown, a pair of openings 104 are formed through each plate 16, and the plates 16 are oriented so that the openings 104 define an inlet passage 106 and an outlet passage 108 through the group of cassettes, and through which the working fluid flows. The inlet and outlet passages 106, 108 may also extend through the lid 22 and, if desired, include fittings 107 and 109 received in corresponding openings 111, 113 in the lid. The working fluid inlet, at least in the example shown, may be considered to include one or both of the fitting 107 and opening 111, and the working fluid outlet may likewise be considered to include one or both of the fitting 109 and opening 113.

As best shown in FIGS. 4 and 8-11, a group of cassettes 92 may be at least partially enclosed by end plates 110 located outboard of and overlying the outermost plates 16 and one or more retainers 112 at or over the sides of the plates to define at least part of a plate pack module 114. The end plates 110 may be complementary in shape to the plates 16 and include ports 116 aligned with the openings 104 in the plates 16. The retainers 112 may overlie or cover at least a portion of the plate peripheries and be connected to at least one end plate 110 to maintain the cassettes 92 within the module 114, provide structural support, acts as a fluid flow director/baffle and/or facilitate movement and handling of the module 114 as a single unit. The end plates 110 and retainers 112 may be welded together or otherwise connected permanently or releasably, and the releasable attachment may or may not require breaking a weld or component to release the components. In the implementation shown, the retainers 112 include arcuate sidewall segments that are connected to both end plates and span a portion of the perimeter of the module. One or more straps 118 (FIG. 11) or other smaller retainers may also be used. Finally, a plurality of mounting tabs 120 may be provided on the module 114 (e.g. coupled to the end plates 110 and/or retainers 112, 118) to facilitate connecting the module 114 to adjacent components, as will be discussed in more detail below.

To inhibit or prevent fluid leakage between adjacent end plates, gaskets 122 or other seals may be provided between adjacent plate pack module end plates 110, as shown in FIGS. 4, 9 and 11. The gaskets 122 or other seals may be arranged around the inlet and outlet ports 116 in each end plate 110 as well as adjacent to the periphery of the end plates, as desired. In the implementation shown, the end plates 110 include grooves formed therein to receive and retain the gaskets. Hence, face-to-face contact between adjacent planar surfaces of the end plates 110 defines part of the sealed fluid flow path without having to connect any passage to a header, tube or other component. Similarly, one or more alignment features may be provided to ensure and retain proper alignment of the modules 114, via adjacent surfaces of the end plates, during assembly. In the implementation shown, alignment rings 124 are provided adjacent to one or both of the inlet and outlet ports 116 in the end plates 110, and the alignment ring 124 of one end plate 110 is received within the corresponding inlet or outlet port 116 of an adjacent end plate 110, or an alignment cavity or groove 125 (FIG. 12), to retain the relative position of the corresponding plate pack modules. Of course, other alignment features may be used instead of or in addition to the illustrated alignment rings.

To provide a fluid flow circuit that enables the desired heat exchange between the treatment and working fluids, the core 12 may include one or more than one plate pack module 114, each plate pack module 114 may include any number of cassettes 92, and the modules within a core may have a different number of cassettes, as desired. In the implementation shown in FIGS. 1-12, the core 12 includes three plate pack modules 114 coupled together about the longitudinal axis 90 such that the core 12 is generally cylindrical, of course other shapes and arrangements are possible. As shown in FIG. 4, the modules 114 in the core 12 are stacked and connected with adjacent end plates 110 parallel and firmly against each other and aligned so that the inlet and outlet passages 106, 108 of each module 114 are aligned and directly communicated with each other.

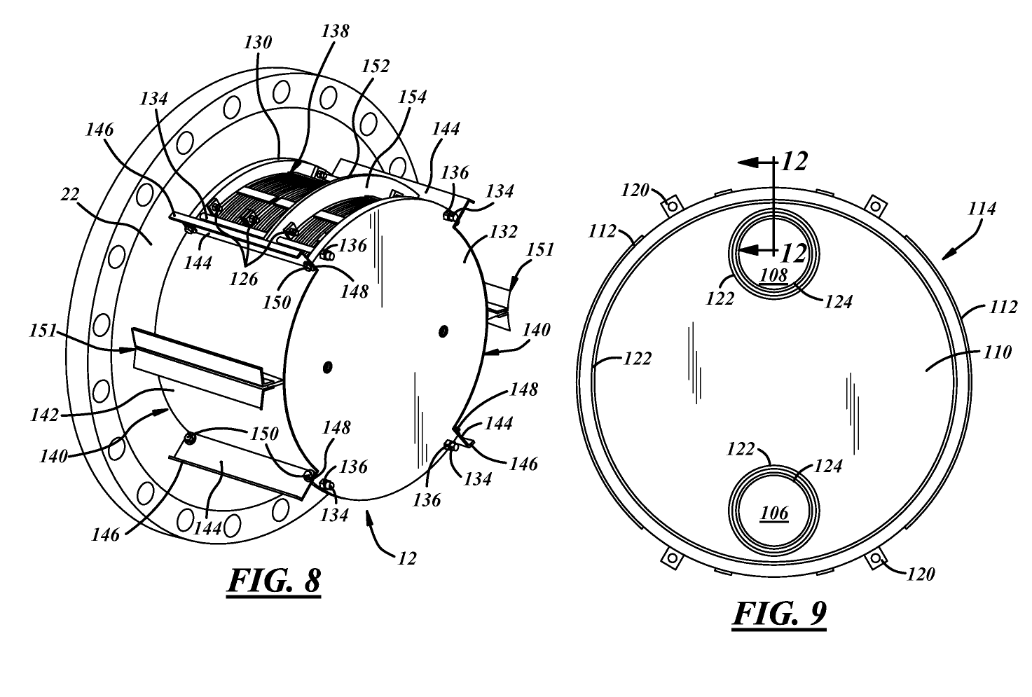

The modules 114 may be held together by any suitable arrangement, including a permanent or releasable connection. In the implementation shown, adjacent modules 114 are releasably coupled by fasteners 126 (FIGS. 7 and 8) associated with the mounting tabs 120. To further unitize the core 12 and/or improve the fluid tight connection between them and facilitate coupling to the lid 22 of the shell 14, the plate pack modules 114 may be further held together by a pair of clamping plates 130, 132 (FIGS. 4 and 8) that are interconnected by tie rods 134 that extend between them. A first clamping plate 130 may be welded or otherwise connected to the lid 22, or it may be an integral portion of the lid (e.g. a feature or all or a portion of a surface in the same block or piece of material and not a discrete component). A second clamping plate 132 may overlie the adjacent and outermost end plate 110 of the outermost plate pack module 114. As shown, the tie rods 134 include threaded ends and nuts 136 are provided on one end and tightened down to firmly clamp the plate pack modules 114 together. Further, the clamping plates 130, 132 may have generally flat/planar inwardly facing surfaces 138 to engage the adjacent plate pack modules 114 and firmly hold the modules together to retain pressure of the fluids within the heat exchanger 10 (e.g. by limiting or preventing expansion or other change in shape of the plates or modules under fluid pressure). The other end of the tie rods 134 may be received in threaded openings in the first clamping plate 130, or may be welded or otherwise connected thereto. Of course, other arrangements may be utilized.

In this way, the plate pack modules 114 are carried by the lid 22 and move with the lid and its carriage 80 as shown by comparison of FIG. 1 and FIG. 3. Also, the plate pack modules 114 may be individually removed from the core 12 for cleaning, replacement or for any other reason, without having to replace all of the plate pack modules. In the illustrated embodiment, this is accomplished by removing the nuts 136 from the tie rods 134 and fasteners 126 from the mounting tabs 120.

Referring to FIGS. 7 and 8, the core 12 may include one or more flow diverters 140 arranged to prevent fluid from flowing only along the periphery of the core 12 and between the core 12 and shell 14. The flow diverters 140 include a wall 142 that may extend about a portion of the circumferential extent of the periphery of the plate pack modules 114 and preferably extend axially between the clamping plates 130, 132 providing a continuous wall surrounding a portion of the periphery of the plate pack modules 114. The diverters 140 may also include one or more flanges 144 that extend radially outwardly from the wall 142 and have an outer edge 146 adapted to engage or nearly engage an inside surface of the shell sidewall 24 to inhibit fluid flow past the flanges 144 and encourage fluid flow into the plate pack modules 114.

In the implementation shown, each diverter 140 includes two circumferentially spaced apart flanges 144, one at each edge of the wall 142, although other arrangements may be used. Also in the implementation shown, two such diverters 140 are provided, generally evenly spaced about the periphery of the core 12. The flanges 144, or other portion of a diverter 140 may be coupled to one or both clamping plates 130, 132. In the implementation shown, the clamping plates 130, 132 include shoulders 148 (FIG. 8) that extend at a complementary angle to the flanges 144 and have a threaded bore into which a fastener 150 is received to retain the diverters 140 relative to the clamping plates 130, 132. A fluid tight connection may be achieved between the diverters 140 and clamping plates 130, 132 to reduce or eliminate fluid flow between them. And this connection may be releasable to permit the diverters 140 to be removed for cleaning, service or replacement, as well as to provide greater access to the plate pack module 114 for cleaning or other service/repair. Of course, other arrangements may be used. In use, fluid flowing about the core 12 that encounters the flow diverters 140 will be directed radially inwardly into the fluid passages 102 defined by the plate cassettes 92.

To further limit or prevent fluid from flowing all the way around a flow diverter 140, between the flow diverter 140 and the shell 14, one or more seals 151 may be disposed adjacent to and extending radially outwardly from the flow diverter walls 142. The seals 151 may extend axially between the lid 22 and second clamping plate 132 or divider plate 32, and may engage the shell sidewall 24 to prevent or substantially inhibit fluid flow past the seals 151. This further promotes fluid flow into the plate pack modules 114 rather than around the periphery of the plate pack modules 114. The seals 151 may be flexible and resilient such that at least part of the seals is resiliently bent or flexed upon engagement with the shell 14 to ensure good contact and a good seal between them. This arrangement may also provide a reactionary force that holds the diverters 140 more tightly against the clamping plates 130, 132 to inhibit or prevent fluid flow between the diverter and clamping plates. If desired, a seal may be located between the diverters and clamping plates. The diverters 140 and/or seals 151 may also act as guides for the core 12 during installation of the core 12 into the shell 14.

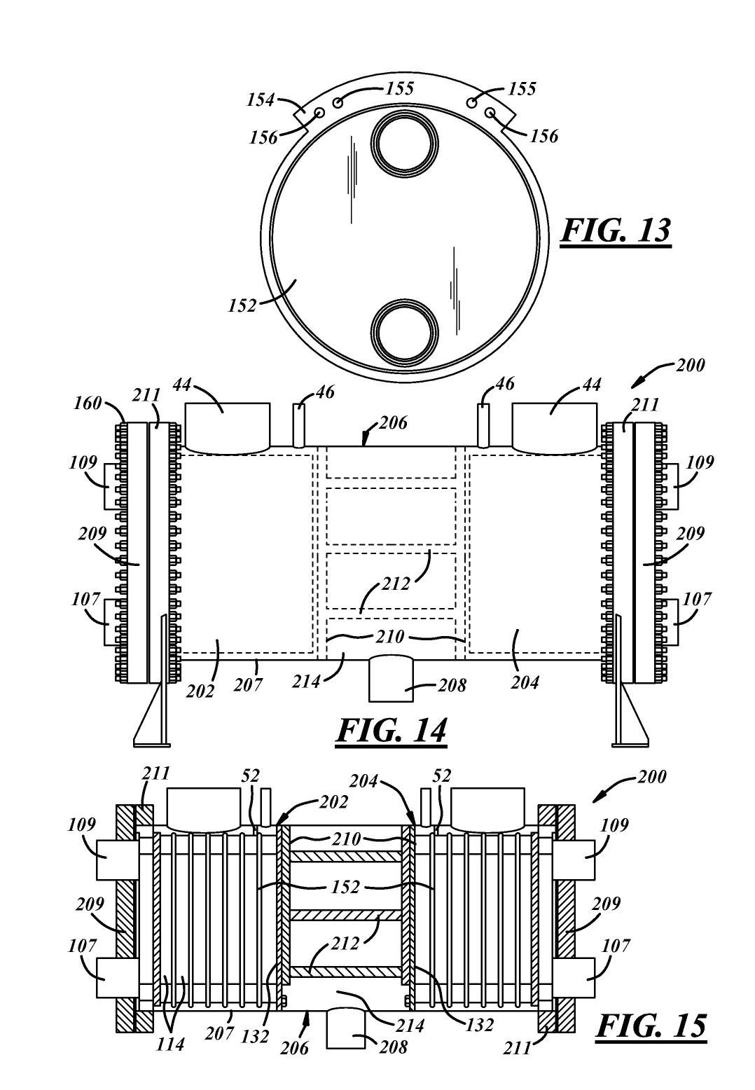

In addition to the flow diverters 140 and seals 151, at least when two treatment fluids are provided, the core 12 may include a structure, shown as a baffle plate 152 (FIGS. 4, 7, 8 and 13), with a portion 154 that extends radially outwardly from periphery of the plate pack modules 114 toward the shell sidewall 24 and extending along a portion of the circumferential extent of the core 12, such as between the flow diverters 140. In assembly of the core 12 within the shell 14, the baffle plate 152 may radially overlap a portion of and engage the baffle flange 52 to inhibit or prevent fluid flow between them. If desired, one or both structures may include or otherwise carry a seal and in the implementation shown, the baffle flange carries a seal 153 (FIG. 5) within a groove formed therein. This provides a partition between the first fluid inlet 44 and the second fluid inlet 46 to maintain the first treatment fluid and second treatment fluid separate from each other as each fluid flows through the core 12. The partition may be provided anywhere in the core 12 to divide the core 12 by the number of plates 16 (or modules 114) desired for the first treatment fluid and the number of plates or modules 114 desired for the second treatment fluid, to effect a desired heat transfer for each treatment fluid. In the implementation shown, the partition provides two plate pack modules 114 for the first treatment fluid and one plate pack module 114 for the second treatment fluid. Of course, any number of plate pack modules 114 can be provided, and the partition can be anywhere desired among the plate pack modules. As shown in FIGS. 4, 7 and 8, the baffle plate 152 is separate from and adjacent to an end plate 110 for one of the plate pack modules 114, but the baffle plate 152 could also define an end plate for one of the modules 114 so that a separate end plate would not be needed. As shown in FIG. 13, except for the outwardly extending segment 154 that is arranged to engage the baffle flange 52, the baffle plate 152 may be constructed like the other end plates 110, and may have openings 155 for connection to the mounting tabs 120 of an end plate 110 from an adjacent module 114. Where tie rods 134 are used, the segment 154 may include openings 156 through which the tie rods 134 extend.

As shown in FIGS. 5 and 6, the divider 32 may likewise be sealed to the shell sidewall 24, at least near the upper portion of the shell sidewall, to inhibit or prevent fluid flow between that portion of the divider 32 and the shell 14. This promotes flow of the second treatment fluid through the core 12 rather than around the core 12. A lower portion 157 of the divider 32 may be spaced from the shell sidewall 24 to permit fluid flow past the divider 32 and to the treatment fluid outlet 56, after that fluid has flowed through the core 12, as will be discussed. Holes 159 may also be provided in the divider 32. The above description relates to a heat exchanger 10 where the treatment fluid flows generally from top-to-bottom as will be discussed in more detail below. If a different flow path is provided, the divider 32 may be sealed to the shell 14 adjacent to the inlet(s) of the treatment fluid(s) and open near the outlet of the treatment fluid flow paths.

Accordingly, partitioned fluid flow into and through the core 12 may be provided between two treatment fluids. In the example of a heat exchanger for a feedwater heater, a first treatment fluid may include steam and a second treatment fluid may include condensate from an upstream heat exchanger that is at an elevated temperature. The condensate from the upstream heat exchanger may be at a higher temperature than the working fluid so that heat transfer from that second treatment fluid to the working fluid is beneficial and more efficient than not using the second treatment fluid at all and wasting its heat. However, it may be desirable to keep the steam (first treatment fluid) separate from the second treatment fluid so that heat from the first treatment fluid is not wasted in heating the second treatment fluid and is instead primarily used to heat the working fluid. The number of plates or plate pack modules 114 devoted to each treatment fluid may be determined based on the relative volume of the fluids entering the fluid inlets, or otherwise, as desired. While a 2:1 ratio of plates/modules has been shown and described, any ratio may be used (e.g. 8:1, 100:1 or more). The treatment fluids may be maintained separate throughout their flow paths in the heat exchanger 10, or the treatment fluids may be combined within the heat exchanger 10. In the implementation shown, the treatment fluids are combined near a bottom of the heat exchanger 10 and both fluids flow out of a common outlet 56.

To assemble the heat exchanger 10, the core 12 is connected to the lid such as by connecting the modules to the first clamping plate 130 via the tie rods 134 and second clamping plate 132. The core and lid assembly is then advanced via the carriage 80 and rails 78 until the core 12 is received within the shell interior 30 and the lid 22 engages the shell flange 36. The lid 22 and flange 36 are releasably coupled together, such as by nuts and bolts 160 as shown, or in any other suitable manner. In reverse order, the core 12 may be removed from the shell 14 to permit cleaning, repair or replacement of any part of or all of the core 12 and its components or the shell 14, and access to the interior of the shell and its internal features or components. The carriage 80 and rails 78 provide controlled, guided movement of the core 12 relative to the shell 14 to facilitate insertion and withdrawal of the core without damaging the heat exchanger components.

Further, in at least certain implementations, the partitioned fluid flow paths are automatically created when the core 12 itself is assembled and when the core is assembled into the shell 14, and all seals 151 and flow directors 140 are in proper position without requiring further or separate handling or manipulation such as connection of tubes, headers or the like. This may be accomplished, for example without limitation, but disposing the baffle flange 52 and baffle plate 152 at an angle not parallel to the path of movement of the core as it is inserted into the shell. As shown, the baffle flange 52 and baffle plate 152 seal at an interface that is perpendicular to the path of movement (and the path of movement in this example is parallel to the longitudinal axis 90). This is also true for the lid 22 to flange 36 seal interface. Of course, other angles can be used. Likewise, the seals between adjacent modules 114 in the core 12, are due to surface-to-surface engagement when the core is assembled and do not require separate connection of tubes, or connection of the modules to a tube or header or the like. And the same is true for the sealed connection between the lid 22 and core 12 which is created by surface-to-surface contact between the clamping plate 130 and the lid 22 when the clamping plate and/or core is coupled to the lid. In this way, when the lid 22 is removed from the main body 20, the core 12 can be easily removed from the shell interior 30 without having to decouple tubes, headers or the like.

When the core 12 is removed from the shell 14, in at least certain embodiments, the core may be completely disassembled for repair, cleaning or replacement of some or all parts. And removal of the core from the shell as well as disassembly of the core can be accomplished nondestructively, which is to say that components or connections between components need not be broken, cut or otherwise altered (e.g. bending, breaking or cutting a weld or component, severing a seam or adhesive/chemical bond, or any other separation process that requires replacing one or more components, connection features or servicing of any components to render them suitable for use again after separation). In this way, the components can be reassembled with minimal additional effort (in at least some applications, it may be desirable to replace at least certain gaskets with new gaskets), and due to the modular nature of the components, they may be readily exchanged for other components as desired. As described and shown, fasteners connect together the lid 22 and main body 20 of the shell 14, fasteners hold the plate pack modules 114 together via the mounting tabs 120, clamping plates 130, 132 and tie rods 134, and fasteners retain the diverters 140 to the clamping plates 130, 132 or other core component(s). All of these fasteners are removable and may be reused (or replaced with like fasteners, if desired) to facilitate assembly and disassembly of the heat exchanger 10 and provide increased utility and versatility in use.

When assembled, the heat exchanger 10 provides fluid flow paths for the treatment fluid and working fluid(s) that are adjacent to each other and separated by the heat transfer plates 16 or other components through which heat may be exchanged/transferred. In this way, heat from the treatment fluid(s) is transferred to the working fluid to increase the temperature of the working fluid. In other implementations, it may be desirable to reduce the temperature of a treatment fluid and this may be done by providing working fluid(s) at an inlet temperature that is less than the inlet temperature of the treatment fluid.

In the implementation shown, the working fluid enters the heat exchanger 10 through its inlet fitting 107 which is located below its outlet fitting 109. The flow path for the working fluid is defined by includes internal passages 102 of the core 12 that open inwardly toward the inlet and outlet passages 106, 108 in the plate pack modules 114 and fluid generally flows from the bottom of the heat exchanger 10 to the top of the heat exchanger 10 in that flow path. Conversely, the treatment fluid inlets 44, 46 are provided at the top of the heat exchanger 10 and flow from the top toward the bottom of the heat exchanger 10. The treatment fluid flow paths originate between the shell 14 and the core 12 and flow through the core 12 in flow passages 103 open to the shell 14 (that is, the gap between the shell and core periphery) and typically alternate or are interleaved with the passages for the working fluid. This provides a counterflow between the working and treatment fluids within the heat exchanger 10 that more effectively transfers heat between the fluids, at least in certain heat exchangers.

To provide even greater surface area for the heat transfer fluid flows, a greater number of plates/plate pack modules 114 may be used. Additionally, as shown in FIGS. 14 and 15, a heat exchanger 200 may include more than one core. In the implementation shown, the heat exchanger 200 includes two cores 202, 204 each received in the same shell 206. In this example, the shell main body 207 is cylindrical and open at both ends with flanges 211 that are arranged to mate with separate lids 209. One core is received in each of the open ends, and this may occur in the same manner as set forth with regard to the heat exchanger 10 of FIGS. 1-13. That is, if desired, each core 202, 204 may be coupled to a guide or track and reciprocated along the guide or track between disassembled and assembled positions. Each core 202, 204 may also be constructed as set forth above with regard to the heat exchanger 10 and its core 12. As shown, each core 202, 204 includes seven plate pack modules 114 with six used for the first treatment fluid and one used for the second treatment fluid.

In the embodiment of FIGS. 14 and 15, if desired and as shown, the treatment fluids from both cores 202, 204 may flow from the heat exchanger 200 through the same outlet 208. Of course, separate outlets may also be provided. Also, two divider plates 210 may be provided, one adjacent to each core 202, 204, and suitable supports 212 may extend between them, if desired. This provides an overflow or collection area 214 between the cores 202, 204 to receive an increased volume of fluid should a failure/breach in a core 202, 204 occur. The dual core heat exchanger 200 can be operated where both cores are used, or where only one of the two cores is used. That is, the operation and fluid flows between the cores can be independent such that only one core might be used if only a reduced capacity of heat exchange is needed, or if the other core is being serviced. The construction and operation of the heat exchanger 200 may otherwise be as described with reference to the heat exchanger 10 so such details will not be repeated. To facilitate description and review of the heat exchanger 200, the same reference numerals have been applied to some of the components that may be the same between the heat exchangers 10 and 200.

Accordingly, heat exchangers have been described that include a shell and a core. The shell defines an interior and includes a lid and a main body to which the lid is coupled in assembly. The core is received in the shell interior and has a plurality of modules, each module including a plurality of cassettes of heat transfer plates, and the modules being releasably coupled together to enable nondestructive decoupling of at least one module from the core. Further, the lid and main body may be releasably coupled together to permit nondestructive removal of the lid from the main body. In this way, the heat exchanger components can be readily assembled and disassembled, serviced, cleaned or replaced, and then reassembled for further use. In some implementations, the core may be carried by the lid so that the core is assembled into the interior when the lid is coupled to the main body. Additionally, all fluid paths and partitions may be fully positioned and operational by merely coupling the lid to the main body, and without having to manually or by another process make fluid connections (e.g. between the core and conduits or headers) within the shell interior.

A representative method of assembling such heat exchangers may involve grouping a plurality of cassettes of heat exchanger plates into a module, releasably coupling together a plurality of modules into a core, and releasably mounting the core within the shell to permit nondestructive removal of the core from the shell and nondestructive removal of at least one module from the core. In at least some implementations, the core may be assembled to the lid and then the lid with the core thereon may be assembled to the main body. When the lid includes a fluid port for admission of fluid into the shell interior and the core includes a passage aligned with the fluid port to receive fluid into the core, surface-to-surface contact of planar surfaces of the core and lid may provide a fluid tight seal between the fluid port and passage. An example of this is shown in FIG. 4 wherein surface-to-surface contact between the lid 22 and clamping plate 130, as well as between the clamping plate 130 and adjacent end plate 110, provide a fluid tight seal for the working fluid inlet and also for the working fluid outlet.

While the forms of the invention herein disclosed constitute presently preferred embodiments, many others are possible. For example, without limitation, the fluid flows can be reversed so that the described outlets become inlets and the described inlets function as outlets. Further, the working fluid could be routed through a flow path described with regard to a treatment fluid, and vice versa. It is not intended herein to mention all the possible equivalent forms or ramifications of the invention. It is understood that the terms used herein are merely descriptive, rather than limiting, and that various changes may be made without departing from the spirit or scope of the invention. Terms like “radially”, “axially” and “circumferentially” are used with reference to an axis of the core and/or shell interior. In instances where the shell and/or core are not generally round/circular, “axially” may be taken to mean parallel to the direction of insertion of the core into the shell, “radially” may be taken to mean perpendicular to “axially” and “circumferentially” can be taken to mean a dimension or direction taken from a given radial distance from an axis, plane or other reference point. Finally, terms like above, below, top and bottom refer to the orientation of the device as shown in the drawings with the understanding that a heat exchanger may be used in a different orientation and this description applies equally to all possible orientations.

1. A shell and plate heat exchanger, comprising:
a shell defining at least part of an interior and having a lid and a main body to which the lid is coupled in assembly; and
a core received in the interior and having a plurality of modules, each module including a plurality of cassettes of heat transfer plates, the modules being releasably coupled together to enable nondestructive decoupling of at least one module from the core and the lid and main body being releasable coupled together to permit nondestructive removal of the lid from the main body.

2. The heat exchanger of claim 1 wherein the core is movable relative to a least a portion of the shell, or at least a portion of the shell is movable relative to the core, along a guide that restricts such relative movement and where the guide is located outside of the shell.

3. The heat exchanger of claim 1 wherein the core is carried by the lid so that the core is assembled into the interior when the lid is coupled to the main body.

4. The heat exchanger of claim 2 wherein the guide includes a track, the core is carried by the lid and the lid is coupled to a carriage moveable along the track relative to the main body.

5. The heat exchanger of claim 1 which also includes clamping plates on opposed sides of the core and adapted to engage adjacent modules of the core and limit expansion of the core under fluid pressure in use.

6. The heat exchanger of claim 1 wherein each module includes a pair of interconnected end plates with one end plate at each of a pair of opposed sides of the plurality of cassettes in the module so that the module defines a single unit including a plurality of cassettes.

7. The heat exchanger of claim 6 wherein the end plates restrain the cassettes within a module against expansion or deformation under fluid pressure in use.

8. The heat exchanger of claim 6 which also includes seals carried by the end plates to provide a fluid tight seal between adjacent end plates of adjacent modules in the core.

9. The heat exchanger of claim 6 which also includes clamping plates on opposed sides of the core, each clamping plate adapted to engage an adjacent end plate of an adjacent module, wherein the clamping plates are releasably coupled together to permit nondestructive decoupling of the clamping plates.

10. The heat exchanger of claim 9 wherein the surface of each clamping plates that engages an end plate is complementary in shape to the end plate to provide uniform surface contact along the engaged portion of the end plate.

11. The heat exchanger of claim 10 wherein the clamping plate surface and engaged portion of the adjacent end plates are both planar.

12. The heat exchanger of claim 1 wherein the shell includes a first fluid inlet, a second fluid inlet and a partition that separates the first fluid inlet from the second fluid inlet to separate fluid flowing into the shell through the first fluid inlet from fluid flowing into the shell from the second fluid inlet during at least a portion of the fluid flow paths of the two fluids within the shell.

13. The heat exchanger of claim 12 wherein the partition is defined in part by a structure sealed to the shell and in part by a structure sealed to the core that is also sealed to the structure sealed to the shell.

14. The heat exchanger of claim 13 wherein the structure sealed to the core engages and seals against the structure sealed to the shell when the core is received in the shell and the lid is coupled to the main body.

15. The heat exchanger of claim 13 wherein each module includes a pair of interconnected end plates with one end plate at each of a pair of opposed sides of the plurality of cassettes in the module and wherein the structure sealed to the core is part of an end plate.

16. The heat exchanger of claim 12 wherein the two fluid flow paths converge prior to an outlet for the two fluids so that both fluids exit the shell from the same outlet.

17. The heat exchanger of claim 12 wherein the fluid flowing into the shell through the first fluid inlet flows through at least one module that is separate from at least one module through which flows the fluid flowing into the shell through the second fluid inlet.

18. The heat exchanger of claim 12 wherein the fluids flowing into the shell through the first fluid inlet and the second fluid inlet are treatment fluids and the treatment fluids are maintained separate from a working fluid that flows into the shell via a working fluid inlet and out of the shell via a working fluid outlet.

19. The heat exchanger of claim 1 which includes a second core and wherein each core includes separate fluid inlets and maintains a fluid flow path that is separate from a fluid flow path in the other core through at least a portion of each core.

20. The heat exchanger of claim 19 wherein in use of the heat exchanger fluid flow may be provided to one core without any fluid flow provided to the other core.

21. The heat exchanger of claim 1 wherein the shell includes a first zone in which the core is received and a second zone defining an open volume spaced from the first zone and capable of receiving fluid flow from the first zone.

22. The heat exchanger of claim 21 wherein a divider is carried by the shell to define part of the first zone and part of the second zone.

23. A method of making a heat exchanger, comprising:
grouping a plurality of cassettes of heat exchanger plates into a module;
releasably coupling together a plurality of modules into a core; and
releasably mounting the core within the shell to permit nondestructive removal of the core from the shell and nondestructive removal of at least one module from the core.

24. The method of claim 23 wherein the shell includes a lid and a main body and the core is coupled to the lid prior to insertion of the core into the main body.

25. The method of claim 24 wherein the lid includes a fluid port and the core includes a passage aligned with the fluid port to receive fluid into the core through the fluid port and passage, and wherein when the core is coupled to the lid, surface-to-surface contact of planar surfaces of the core and lid provide a fluid tight seal between the fluid port and passage.

26. The method of claim 23 which also includes installing a pair of clamping plates against the outermost sides of the plurality of modules to limit outward expansion of the modules under fluid pressure, and wherein the clamping plates are releasably coupled together to permit nondestructive decoupling of the clamping plates for access to said at least one module that is nondestructively removable from the core.

27. The method of claim 23 which also includes establishing a partition within the heat exchanger upon insertion of the core into the shell by engagement of a structure carried by the shell with a structure carried by the core.
